(19) United States
(12) Patent Application Publication
(10) Pub. No.: US 2007/0111607 A1
(43) Pub. Date: May 17, 2007

(54) Miniature audio jack connector with improved contact arrangement

(75) Inventors: Zi-Qiang Zhu, Kunshan (CN); Hong-Qiang Han, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/599,658

(22) Filed: Nov. 14, 2006

(30) Foreign Application Priority Data
Nov. 14, 2005 (CN) 200520077822.6

(51) Int. Cl. H01R 24/04

(52) U.S. Cl. 439/669

(57) ABSTRACT

A miniature audio jack connector (100) for electrically connecting a mating plug (5) includes an insulative housing (1), a number of contacts (2) retained in the housing. The housing defines a plug-insertion hole (12) in a longitudinal direction thereof. The contacts include a second contact (22) and a third contact (23). The second contact includes a second retaining portion (220) and a second elastic arm (221) extending into the plug-insertion hole. The third contact includes a third retaining portion (230) and a third elastic arm (231) extending opposite to the second elastic arm. The second and third retaining portions (220, 230) overlap each other along the longitudinal direction of the housing (1), thereby lengthening the elastic arms (221, 231) of the contacts (22, 23) to be reliable connecting with the mating plug.

### BACKGROUND OF THE INVENTION

1. Field of the Invention

This invention generally relates to an audio jack connector, and more particularly to a miniature audio jack connector with reliable structure for mating with a corresponding plug.

2. Description of the Prior Art

U.S. Pat. No. 5,338,215 discloses a conventional audio jack connector comprising an insulative housing and a plurality of contacts accommodated in the insulative housing. The insulative housing includes a plug-insertion hole extending therethrough. The contacts include a first, a second and a third contact retained in a same side of the housing. The first, second and third contacts are arranged in a longitude direction of the insulative housing. Each contact includes a retaining portion, a spring arm extending into the plug-insertion hole for mating with a plug, and a soldering portion extending beyond the same side wall of the insulative hosing for being mounted on a printed circuit board. However, when this contact arrangement is used in a miniature audio jack connector, the elasticity of the spring arms is restricted because the length of the spring arms is not big enough.

Hence, it is desired to have a miniature audio jack connector with improved contact arrangement therefore solving the problem above.

### BRIEF SUMMARY OF THE INVENTION

Accordingly, an object of the present invention is to provide a miniature audio jack connector with contacts having good elasticity function.

In order to attain the objective above, a miniature audio jack connector for electrically connecting a mating plug, comprises an insulative housing and a plurality of contacts retained in the housing. The housing includes a base, a cylinder-shaped mating portion extending forwardly from the base, and a plug-insertion hole through the mating portion and the base. The contacts include a first contact, a second contact and a third contact. The top wall defines a set of first, second and third mounting holes along the longitude direction of the housing for accommodating the contacts thereof. Each contact defines a retaining portion fixed in the corresponding mounting hole, an elastic arm extending into the plug-insertion hole, and a soldering portion extending beyond the same side wall of the housing. The second and third retaining portions at least partially overlap with each other in the longitudinal direction of the housing. The second and third retaining portions are spaced apart from each other in a direction substantially perpendicular to the longitudinal direction. With this arrangement, the elastic arms of the contacts are lengthened to be reliable connecting with the mating plug.

Other objects, advantages and novel features of the invention will become more apparent from the following detailed description of the present embodiment when taken in conjunction with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of a miniature audio jack connector according to the present invention;

FIG. 2 is another perspective view shown in FIG. 1;

FIG. 3 is a top plan view of the miniature audio jack shown in FIG. 2;

FIG. 4 is an exploded view of the miniature audio jack connector shown in FIG. 1, in conjunction with a plug and a printed circuit board on which the audio jack connector is mounted;

FIG. 5 is another exploded view of FIG. 4; and

FIG. 6 is a perspective view of the miniature audio jack connector mounted on the printed circuit board with the mating plug inserted therein.

### DETAILED DESCRIPTION OF THE INVENTION

Reference will now be made in detail to the preferred embodiment of the present invention.

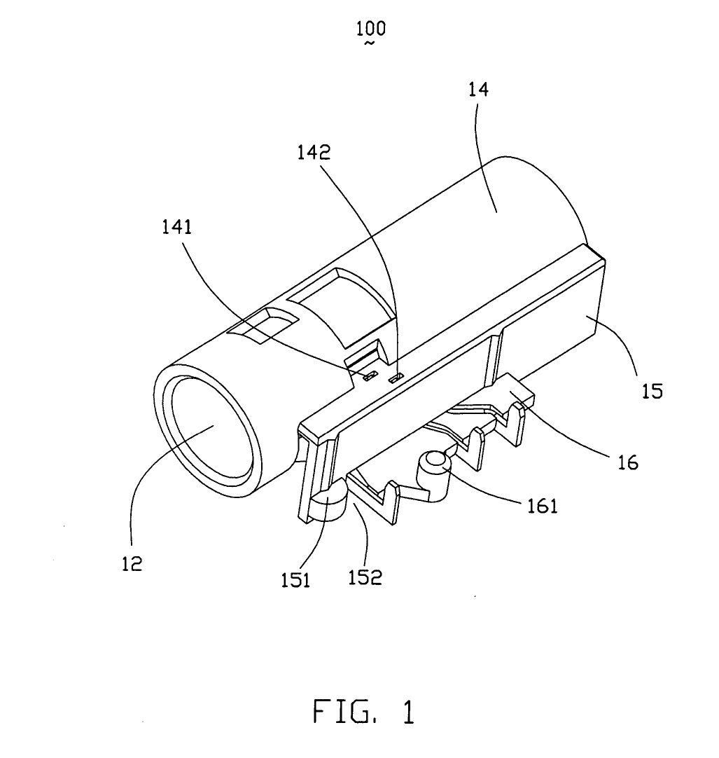

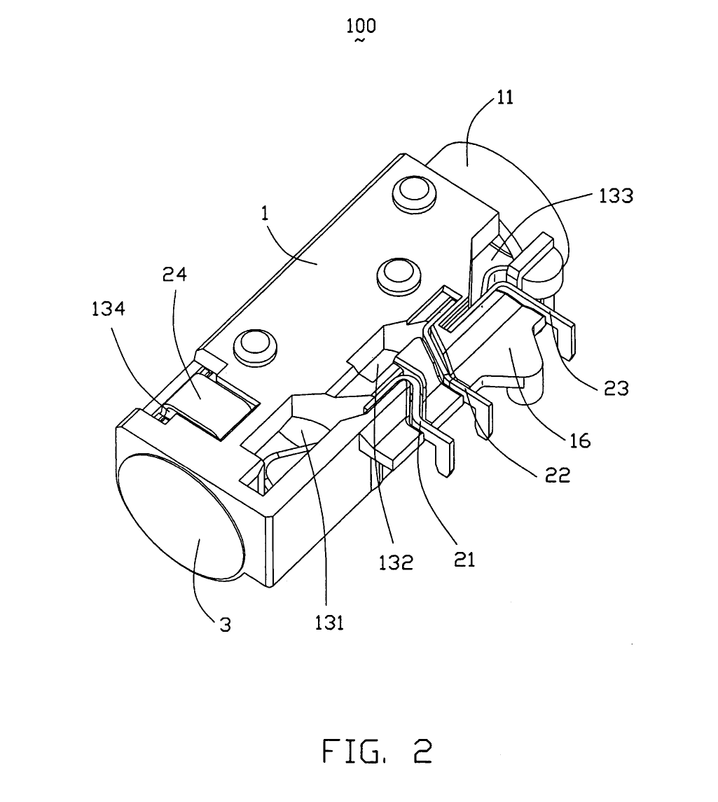

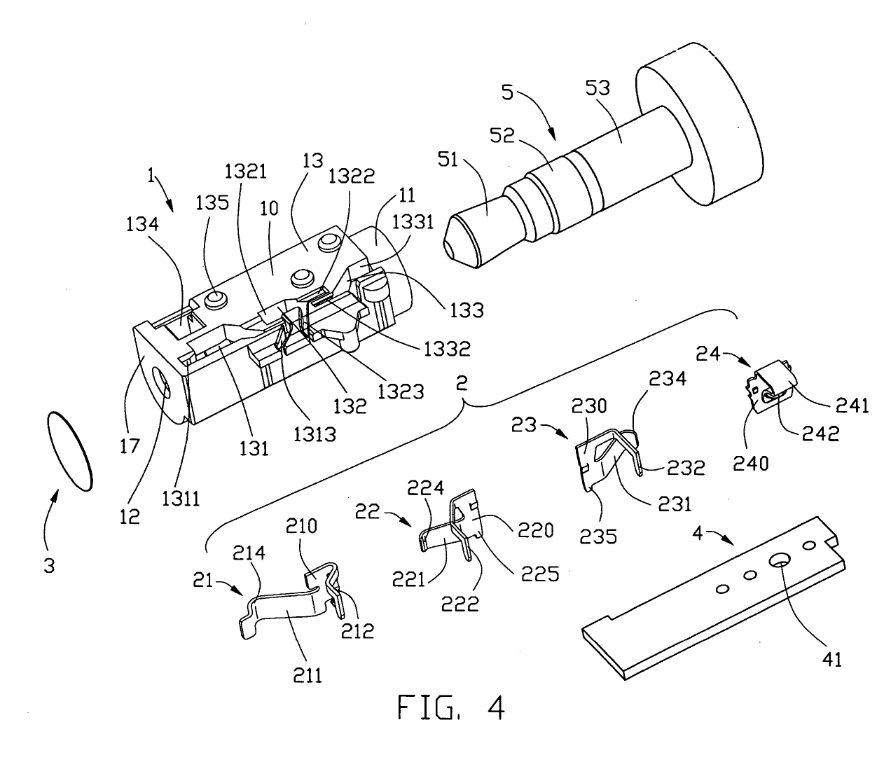

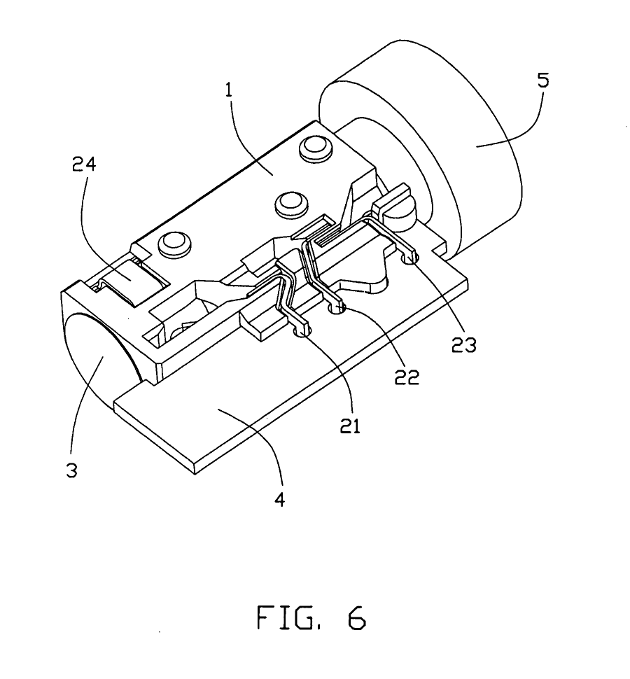

Refer to the drawings and in particular to FIGS. 1-2, a miniature audio jack connector 100 in accordance with the present invention for electrically connecting a mating plug 5 (shown in FIGS. 4-6), comprises an insulative housing 1, a plurality of contacts 2 retained in the insulative housing 1 and a rear cover 3 for locking with the insulative housing 1.

Referring to FIGS. 1-5, the insulative housing 1 comprises a base 10, a cylinder-shaped mating portion 11 extending forwardly from the base 10 and a plug-insertion hole 12 extending through the mating portion 11 and the base 10. The base 10 forms a flat rear wall 17, a top wall 13, a pair of side walls 15, 18 perpendicularly to the top wall 13, and an arched bottom wall 14 opposite to the rear wall 17. A connecting portion 16 is integrally extending outward from the side wall 15. The top wall 13 defines a set of first, second and third mounting holes 131, 132, 133 adjacent to the side wall 15 along the longitude direction of the housing 1. A fourth mounting hole 134 is disposed beside another side wall 18 and opposite to the first mounting hole 131. The mounting holes 131, 132, 133, 134 are in communication with the plug-insertion hole 12 for receiving the contacts 2 thereof. The top wall 13 further defines a plurality of first post 135 for position purpose. The side wall 15 defines a protrusion 151 in front of the connecting portion 16 and forming a gap 152 between the protrusion 151 and the connecting portion 16. The connecting portion 16 includes a second post 161 receivable in a hole 41 defined in a printed circuit board (PCB) 4 for positioning purpose (seen in FIG. 4). The bottom wall 14 is arch shaped and includes a pair of first and second recesses 141, 142 in communication with the mounting holes 132, 133 respectively.

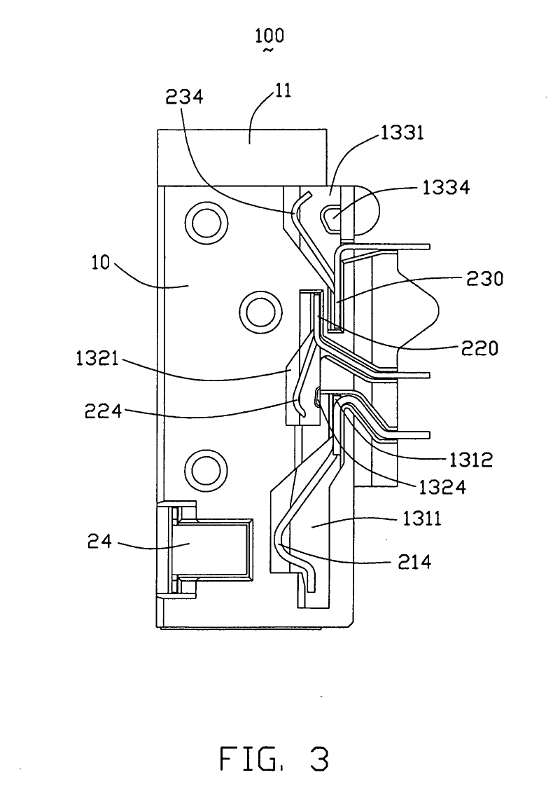

Referring to FIGS. 3-5, the contacts 2 include a first contact 21, a second contact 22, a third contact 23 and a retaining contact 24. All the contacts 21, 22, 23, 24 are made of conductive material and accommodated in the mounting holes 131, 132, 133, 134 respectively from the top wall 13 of the insulative housing 1.

Referring to FIG. 4, the first contact 21 includes a planer shaped first retaining portion 210, a first elastic arm 211 extending forward from the first retaining portion 210, and a first soldering portion 212 extending sideward from the first retaining portion 210. The second contact 22 contains a vertical second retaining portion 220, a second elastic arm 221 extending from the lower side of the retaining portion 220, and a second soldering portion 222 extending from the lower side of the retaining portion 220. The third contact 23 are probably in the same configuration of the second contact 22. The third contact 23 contains a vertical third retaining portion 230, a third elastic arm 231 extending from the lower side of the retaining portion 230, and a third soldering portion 232 extending from the lower side of the retaining portion 230. The first, second and third soldering portions 212, 222 and 232 are L-shaped wherein the soldering portions 212, 222, 232 extend over the elastic arms 211, 221, 231 respectively. The first and second arms 211, 221 extend in a same direction while the second and third arms 221, 231 extend in an opposite direction so as to arrange the contacts 22, 23. The first and second mounting holes 131, 132 are adapted for accommodating the contacts 21, 22 configured to the mounting holes 131, 132 respectively. The first mounting hole 131 defines a first opening 1311 for accommodating the first elastic arm 211, a first slit 1312 extending forward from the first opening 1311 for fixing the first retaining portion 210, and a first slot 1313 in communication of the first slit 1312 for retaining the first soldering portion 212. The second mounting hole 132 is Y-shaped and comprises a second opening 1321 for accommodating the second elastic arm 221, a second slit 1322 extending forward from the second opening 1321 for fixing the second retaining portion 220, and a second slot 1323 in communication of the second slit 1322 for retaining the second soldering portion 222. The third mounting hole 133 defines a third opening 1331 for accommodating the third elastic arm 231 and a third slit 1332 extending backward from the third opening 1331 for fixing the third retaining portion 230. The third soldering portion 232 is extending through the gap 152. The soldering portions 212, 222, 232 are extending beyond the connecting portion 16 from the same side wall 15 of the insulative housing 1, thereby facilitating the soldering portions 212, 222, 232 to be soldered to the PCB 4. Each elastic arm 211, 221, 231 defines an engaging portion 214, 224, 234 projecting into the plug-insertion hole 12 for engaging with the mating plug 5 (seen in FIGS. 4-6). Each planer shaped retaining portion 220, 230 further defines a tab 225, 235 fixed in the first and second recesses 141, 142. The first slit 1312 and third slit 1332 are disposed in a line. The second slit 1322 is set on the left side of the third slit 1332 wherein the second slit 1322 is parallel to the third slit 1332. The second slit 1322 overlaps the third slit 1332 along a direction substantially perpendicularly to the longitude direction of the housing 1. The first and second slots 1313, 1323 are extending through the connecting portion 16. The second and third openings 1321, 1331 respectively include a second position block 1324 and a third position block 1334 wherein the position blocks 1324, 1334 are adapted for abutting against the contacts for over pressure when the mating plug 5 is inserted in the plug-insertion hole 12.

The retaining contact 24 is retained in the fourth mounting hole 134 and includes a stationary portion 240 and a resilient portion 241 extending and bending from the upper edge of the stationary portion 240. The resilient portion 241 further forms a calotte emboss 242 extending into the plug-insertion hole 12 for abutting against the plug 5 and enhancing engaging force.

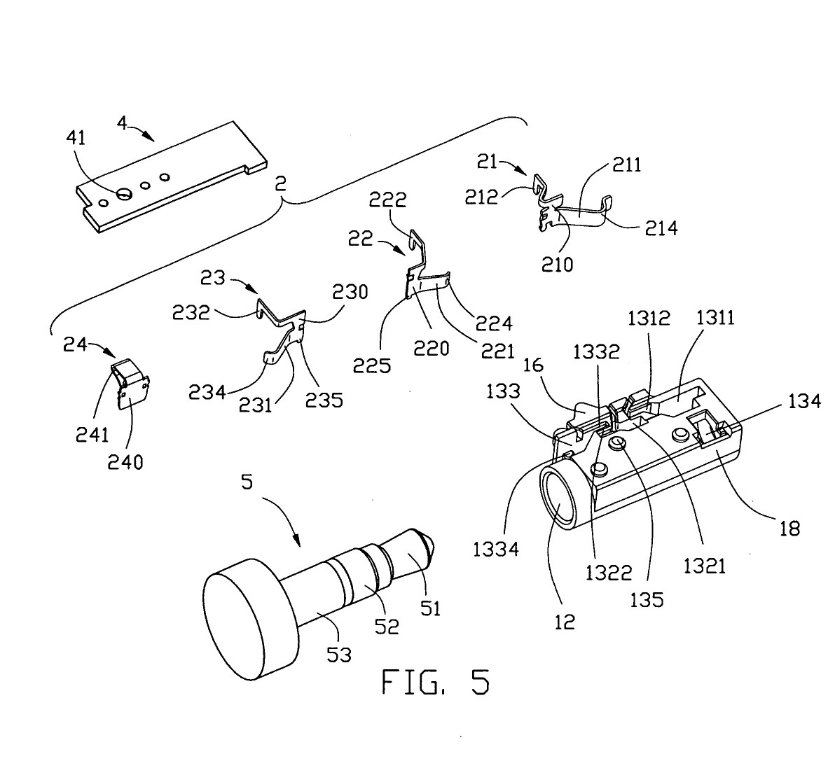

Referring to FIGS. 4-5, the mating plug 5 comprises a first contact section 51, a second contact section 52 and a third contact section 53. With insertion of the plug 5, the first, second and third contact sections 51, 52 and 53 electrically connect the engaging portions 214, 224 and 234 of the first, second and third elastic arms 211, 221 and 231 respectively.

Comparing with the prior art, the second and third retaining portions 220, 230 at least partially overlap with each other in the longitudinal direction of the housing 1. The second and third retaining portions 220, 230 are spaced apart from each other in a direction substantially perpendicular to the longitudinal direction. With this arrangement, the elastic arms 221, 231 of the contacts 22, 23 are lengthened to be reliable connecting with the mating plug 5. Besides, the L-shaped soldering portions 212, 222, 232 extend beyond the connecting portion 16 from the same side wall 15 of the insulative housing 1, thereby facilitating the soldering portions 212, 222, 232 to be soldered to the PCB 4.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. An audio jack connector for electrically connecting a mating plug, comprising:
an insulative housing defining a plug-insertion hole in a longitudinal direction thereof; and
a pair of contacts retained in the same side of the insulative housing and comprising a second contact and a third contact, the second contact including a second retaining portion and a second elastic arm extending from the second retaining portion, the third contact including a third retaining portion and a third elastic arm extending from the third retaining portion in a direction opposite to the extending direction of the second elastic arm, the second and third retaining portions at least partially overlapping with each other in the longitudinal direction, and being spaced apart from each other in a direction substantially perpendicular to the longitudinal direction, said second and third elastic arms extending into the plug-insertion hole for mating with the plug.

2. The audio jack connector according to claim 1, wherein the second contact includes a second soldering portion, the second soldering portion and the second elastic arm extending from an upper and a lower side of the second retaining portion respectively.

3. The audio jack connector according to claim 2, wherein the third contact includes a third soldering portion, the third soldering portion and the third elastic arm extending from an upper and a lower side of the third retaining portion respectively.

4. The audio jack connector according to claim 3, wherein the insulative housing includes a base and a connecting portion integrally extending from the base.

5. The audio jack connector according to claim 4, wherein the second and third soldering portions are L-shaped and extend beyond the connecting portion to be electrically connected to a printed circuit board.

6. The audio jack connector according to claim 1, wherein the second and third retaining portions are planar shaped.

7. The audio jack connector according to claim 6, wherein the peripheral wall defines a second slit and a third slit substantially parallel to the second slit, the second and third retaining portions vertically received the second and third slits respectively.

8. The audio jack connector according to claim 7, wherein the insulative housing defines a second opening in communicating with the second slit and a third opening in communication with the third slit, the second and third openings being adapted for accommodating the second and third elastic arms respectively.

9. The audio jack connector according to claim 8, wherein insulative housing forms a pair of position blocks in the second and third openings for engaging with the corresponding elastic arms with insertion of the mating plug.

10. The audio jack connector according to claim 1, further comprising a first contact disposed along the same side of the second and third contacts in the longitudinal direction of the housing.

11. The audio jack connector according to claim 10, wherein the housing defines a first mounting hole for receiving the first contact, the first contact including a first elastic arm extending in a same direction of the second elastic arm.

12. The audio jack connector according to claim 11, further comprising a retaining contact, the insulative housing defining a fourth mounting hole opposite to the first mounting hole for accommodating the retaining contact, said retaining contact having a resilient portion extending into the plug-insertion hole for abutting against the plug.

13. The audio jack connector according to claim 1, wherein the insulative housing includes an arched bottom wall.

14. An audio jack connector assembly, comprising:
an insulative housing defining a plug-insertion hole in a longitudinal direction thereof;
a plurality of contacts retained in the same side of the insulative housing and including a first, a second and a third contact, the first, second and third contacts respectively including a first, a second and a third retaining portion and a first, a second and a third elastic arm extending from corresponding retaining portion, the second and third retaining portions at least partially overlapping with each other in the longitudinal direction, and being spaced apart from each other in a direction substantially perpendicular to the longitudinal direction, said second and third elastic arms extending into the plug-insertion hole for mating with the plug; and
a mating plug comprising a first, a second and a third contact section adapted for electrically connecting the first, second and third elastic arms respectively.

15. The audio jack connector assembly according to claim 14, wherein the first and second elastic arms extend in a same direction while the second and third elastic arms extend in an opposite direction.

16. The audio jack connector assembly according to claim 14, wherein the insulative housing includes a base and a connecting portion integrally extending sideward from the base.

17. The audio jack connector assembly according to claim 16, wherein the first, second and third contacts respectively having a first, second and third soldering portions extending beyond the connecting portion to be electrical connected to a printed circuit board.

18. An audio jack assembly comprising:
a printed circuit board;
an tubular type insulative housing located adjacent to the printed circuit board and defining a plug-receiving hole extending along a front-to-back direction;
a contact platform formed on one lateral side of housing in a transverse direction perpendicular to said front-to-back direction;
a plurality of passageways downwardly extending into the housing from a top face thereof;
a plurality of terminals disposed in the corresponding passageways, respectively, each of said terminals defining a mating portion extending into the plug-receiving hole and a solder tail exposed outside of the housing around said lateral side to be fastened to the printed circuit board; wherein
said platform functions as not only a spacer to regulate the solder tail but also a supporting device holding the housing upon the printed circuit board.

19. The assembly as claimed in claim 18, wherein the solder tails are of an right angle form.
